(19) United States
(12) Patent Application Publication
(10) Pub. No.: US 2012/0077726 A1
(43) Pub. Date: Mar. 29, 2012

(54) GENTLE BLEACHING AGENT

(75) Inventors: Anette Nordskog, Sandefjord (NO); Wolfgang von Rybinski, Dusseldorf (DE); André Hätzelt, Dusseldorf (DE); Siglinde Erpenbach, Monheim (DE); Matthias Ballauf, Bayreuth (DE); Frank Polzer, Bayreuth (DE)

(73) Assignee: Henkel AG & Co. KGaA, Dusseldorf (DE)

(21) Appl. No.: 13/313,219

(22) Filed: Dec. 7, 2011

Related U.S. Application Data
(63) Continuation of application No. PCT/EP2010/057413, filed on May 28, 2010.

(30) Foreign Application Priority Data
Jun. 8, 2009 (DE) 10 2009 026 811.1

(51) Int. Cl. D06L 3/02; C11D 3/60; C11D 3/395

(52) U.S. Cl. 510/311; 8/111; 252/186.1

(57) ABSTRACT

The aim of the invention is to reduce the damage to cellulosic material during the bleaching treatment of cellulosic material by using catalysts with bleaching activity, without significantly impacting the bleaching performance in the process. This was achieved largely by way of a method for bleaching cellulosic material in the presence of a peroxygen-containing bleaching agent and a bleach-boosting transition metal complex, which is carried out in the presence of spherical polyelectrolyte brushes. The spherical polyelectrolyte brushes preferably contain the transition metal complex in a colloidally bound manner.

### CROSS-REFERENCES TO RELATED APPLICATIONS

This application is a continuation of PCT/EP2010/057413, filed on May 28, 2010, which claims priority under 35 U.S.C. §119 to DE 10 2009 026 811.1 filed on Jun. 8, 2009, both of which are hereby incorporated by reference.

### FIELD OF THE INVENTION

The present invention generally relates to the use of spherical polyelectrolyte brushes (SPBs) to reduce the damage of bleach-activating transition metal complexes in treating cellulosic material, in particular in washing textiles; it also relates to a gentle method for treating cellulosic material in the presence of a peroxygen-containing bleaching agent and a bleach activating transition metal complex, agents containing peroxygen-containing bleaching agent and SPBs, bleach-activating transition metal complex in a colloidally bound form as well as a method for producing SPBs containing the bleach-activating transition metal complex in a colloidally bound form.

### BACKGROUND OF THE INVENTION

Inorganic peroxygen compounds, in particular hydrogen peroxide and solid peroxygen compounds which dissolve in water and release hydrogen peroxide such as sodium perborate and sodium percarbonate perhydrate have long been used as oxidizing agents for disinfection and bleaching purposes. The oxidizing effect of these substances in dilute solutions depends greatly on the temperature. Thus, for example, sufficiently rapid bleaching of soiled textiles is achieved with H₂O₂ or perborate in an alkaline bleaching solution only at temperatures above approx. 80° C. At lower temperatures, the oxidizing effect of the inorganic peroxygen compounds can be improved by adding so-called bleach activators, which have become known in the literature for numerous proposals, especially from the substance classes of N- or O-acyl compounds for example polyacylated alkylene diamines in particular tetraacetylethylenediamine, acylated glycolurils, in particular tetraacetyl glycoluril, N-acylated hydantoins, hydrazides, triazoles, hydrotriazines, urazoles, diketopiperazines, sulfurylamides and cyanurates as well as carboxylic acid anhydrides, in particular phthalic acid anhydride, carboxylic acid esters, in particular sodium nonanoyloxybenzene sulfonate, sodium isononanoyloxybenzene sulfonate and acylated sugar derivatives such as pentaacetyl glucose. By adding these substances, the bleaching effect of aqueous peroxide baths can be increased to the extent that essentially the same effects are already achieved at temperatures around 60° C. as with the peroxide solution alone at 95° C. Damage to the tissue remains within a range that is acceptable for the consumer.

In recent years, use temperatures definitely below 60° C., in particular below 45° C. down to the temperature of cold water, have become increasingly important in efforts to save energy in the washing and bleaching operations.

At these low temperatures, the effect of the activator compounds known in the past usually declines noticeably. Therefore there has been no lack of efforts to develop more effective bleaching systems for this temperature range. One approach to this is obtained by using compounds which supply hydrogen peroxide together with transition metal salts and complexes as so-called bleach catalysts. However, with these catalysts, there is the risk of oxidative damage to textiles, presumably because of the high reactivity of the oxidizing intermediates formed from them and the peroxygen compound. Use of such transition metal catalysts in detergents has previously been difficult in practice because damage to the fabric is then much greater than it is with a conventional system of bleaching agent and bleach activator, which forms a peracid. The same is logically also true of bleaching processes performed in the production of cellulosic materials such as pulp or paper.

Accordingly, it is desirable to reduce damage to the cellulosic material for example a textile when using bleach-active catalysts in the bleaching treatment of cellulosic material, for example, in washing textiles, and to do so without significantly altering the bleaching performance.

Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

One aspect of the present invention relates to a bleaching agent in the form of a spherical polyelectrolyte brush (SPB) containing a bleach-activating transition metal complex compound in colloidally bound form.

A method is provided for producing spherical polyelectrolyte brushes (SPBs), which contain the bleach-activating transition metal complex compound in colloidally bound form, wherein a bleach-activating transition metal complex compound is brought in contact with a spherical polyelectrolyte brush (SPB) in the presence of water.

A method is provided for producing spherical polyelectrolyte brushes (SPBs), which contain a bleach-activating transition metal complex compound in colloidally bound form, wherein one or more ligands capable of forming a bleach-potentiating transition metal complex in situ with a transition metal and the corresponding transition metal in salt form or in the form of a non-bleach-active complex are brought in contact with a spherical polyelectrolyte brush (SPB) in the presence of water.

A method is provided for bleaching treatment of cellulosic material, in particular in the production of cellulose or paper or in washing textiles in the presence of a bleaching agent which contains peroxygen and of a bleach-potentiating transition metal complex, wherein it is performed in the presence of spherical polyelectrolyte brushes (SPBs).

A detergent which is gentle to textiles and contains a bleaching agent, which in turn contains peroxygen, bleach-potentiating transition metal complex or one or more ligands capable of forming a bleach-potentiating transition metal complex in situ with a transition metal in the washing process, and spherical polyelectrolyte brushes (SPBs), in particular SPBs containing the bleach-potentiating transition metal complex in colloidally bound form.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

When linear polyelectrolyte chains are bound to latex particles, this yields spherical polyelectrolyte brushes (SPBs). Linear polyelectrolyte chains can be obtained by polymerization of ethylenically unsaturated carboxylic acids, for example. Latex particles are accessible by emulsion polymerization of styrene, for example. If the surface of the latex particle is covered with a thin layer of a photoinitiator, the polymerization of ethylenically unsaturated carboxylic acids, such as acrylic acid, for example, can be initiated by irradiation of the latex core covered with the photoinitiator, so that the polyelectrolyte is grafted onto the latex core, as described by X. Guo, A. Weiss and M. Ballauff in Macromolecules, 1999, pp. 6043-6046.

The invention claimed here is based centrally on the fact that the damage to cellulosic material caused by bleach-active catalysts is reduced if the catalyst is embedded between the polyelectrolyte chains arranged spherically around the latex core in a brush pattern.

One aspect of the present invention is therefore a method for producing spherical polyelectrolyte brushes (SPBs), which contain the bleach-activating transition metal complex compound in a colloidally bound form, such that the bleach-activating transition metal complex compound is brought in contact with a spherical polyelectrolyte brush (SPB) in the presence of water.

The molar ratio between the molar number of functional groups in the polyelectrolyte shell to the added transition metal complex compound is preferably in the range of 100:1 to 2:1, in particular in the range of 10:1 to 4:1.

The inventive production process is preferably performed at temperatures in the range of 10° C. to 70° C., in particular from 20° C. to 25° C. In other preferred embodiments of the production process, it is carried out a pH in the range of pH 4 to pH 10, in particular pH 5 to pH 8, which can be adjusted by adding the usual acids or bases that are compatible with the system. The process preferably starts with the spherical polyelectrolyte brushes and then the bleach-activating transition metal complex compound is added, the dosing time usually being in the range of 10 minutes to 1 hour, in particular approx. 30 minutes, but it may also be less than 1 sec, in particular at small quantities, or it may approach the infinite, for example, when using controlled ion exchange via ultrafiltration. After the end of the addition of the bleach-activating transition metal complex compound, equilibration is preferably performed for 30 minutes to 48 hours, in particular for 1 hour to 24 hours, preferably with agitation. One alternative variant of the inventive production process consists of bringing one or more ligands, which are capable of forming a bleach-activating transition metal complex with a transition metal in situ, and the corresponding transition metal in salt faun or in the form of a non-bleach-active complex, in contact with a spherical polyelectrolyte brush (SPB) in the presence of water, such that the conditions specified above are also maintained appropriately, so that the bleach-activating transition metal complex compound is formed only in the presence of the SPB. The separate step of bringing them in contact may be accomplished by simultaneous or successive addition, but in the latter alternative, the transition metal is preferably added to the SPB before the ligand.

Another subject matter of the present invention is a spherical polyelectrolyte brush (SPB) containing a bleach-activating transition metal complex compound in colloidally bound form.

The bleach-activating transition metal complex compounds are embedded in the grafted polyelectrolyte side chains of the spherical polyelectrolyte brush by the inventive production process and are thereby stabilized. The catalyst surface is still readily accessible for substrates which are in aqueous solution or dispersion. Larger objects, for example, the surface of a textile to be washed or a hard object to be cleaned, cannot come in direct contact with its catalytic center because the catalyst is embedded, so there cannot be any oxidation of these surfaces catalyzed by the bleach catalyst.

From this standpoint, another subject matter of the present invention is therefore a method for bleaching treatment of cellulosic material, in particular in the production of cellulose or paper or in washing textiles in the presence of a peroxygen-containing bleaching agent and a bleach-activating transition metal complex, which is characterized in that it is performed in the presence of spherical polyelectrolyte brushes (SPBs).

Bleach-activating transition metal complex compounds that may be used include in particular those of the metals Fe, Mn, Co, V. Ru, Ti, Mo, W, Cu and/or Cr, for example, manganese-, iron-, cobalt-, ruthenium- or molybdenum-salene complexes, manganese-, iron-, cobalt-, ruthenium- or molybdenum-carbonyl complexes, manganese, iron, cobalt, ruthenium, molybdenum, titanium, vanadium and copper complexes with nitrogen-containing tripod ligands, cobalt-, iron-, copper- and ruthenium-amine complexes and iron or manganese complexes with polyazacycloalkane ligands, such as TACN.

The preferred bleach-activating transition metal complex compounds include metal complexes of formula (I):

[LₙMₘXₚ]^{z}Y_{q} (I)

where M denotes manganese or iron or mixtures of these metals, which may be present in oxidation states II, III, IV or V, or mixtures of same, n and m, independently of one another, are integers with a value of 1 to 4, X is a coordinating or bridging species, p is an integer with a value of 0 to 12, Y is a counterion, whose type depends on the charge z of the complex, which may be positive, zero or negative, q=z/[charge Y] and L is a ligand, which is a macrocyclic organic molecule of the general formula:

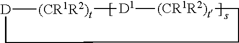

in which each of the radicals R¹ and R² may be zero, H, alkyl or aryl, optionally substituted; t and t′, independently of one another, are 2 or 3; D and D¹, independently of one another, are N, NR, PR, O or S, wherein R is H, alkyl or aryl, optionally substituted, and S is an integer with a value of 2 to 5, wherein if D=N, then one of the heterocarbon bonds bound thereto is unsaturated, which leads to the creation of an N═CR¹ fragment. The preferred metal M is manganese. The coordinating or bridging species X is preferably a small coordinating ion or bridging molecule or a mixture of same, for example, water, OH⁻, O²⁻, S²⁻, S(═O), N³⁻, HOO, O₂²⁻, O₂⁻, amine, Cl⁻, SCN⁻, N₃⁻, and carboxylate, for example, acetate or mixtures thereof. If the charge z is positive, then Y is an anion, for example, chloride, bromide, iodide, nitrate, perchlorate, rhodanide, hexafluorophosphate, sulfate, alkyl sulfate, alkyl sulfonate or acetate; if the charge z is negative, Y is a cation, for example, an alkali ion, an ammonium ion or an alkaline earth ion. The preferred ligands L include 1,4,7-triazacyclononane, 1,4,7-trimethyl-1,4,7-triazacyclononane, 1,5,9-trimethyl-1,5,9-triazacyclododecane and 1,2,4,7-tetramethyl-1,4,7-triazacyclononane.

In another preferred embodiment, the bleach-activating transition metal complex compound corresponds to general formula (II)

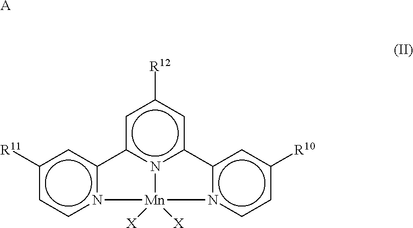

in which R¹⁰ and R¹¹, independently of one another, stand for hydrogen, a C₁₋₁₈ alkyl group, a group NR¹³R¹⁴, a group N⁺R¹³R¹⁴R¹⁵ or a group

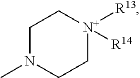

R¹² stands for hydrogen, OH or a C₁₋₁₈ alkyl group, R¹³, R¹⁴ and R¹⁵, independently of one another, stand for hydrogen, a C₁₋₄ alkyl or hydroxyalkyl group, X stands for halogen, and A stands for a charge equalizing anion ligand, which may also be absent or may be present several times, depending on its charge and the type and number of other charges, in particular the charge of the manganese central atom. Manganese may have oxidation stages II, III, IV or V therein as well as in the complexes according to formula (I). If desired, although less preferred, other transition metals, for example, Fe, Co, Ni, V, Ru, Ti, Mo, W, Cu and/or Cr may also be present instead of the Mn central atom in such complex compounds.

The inventive method for bleaching treatment of cellulosic material may, if desired, be performed at temperatures in the range of 10° C. to 95° C. The temperature is preferably in the range of 20° C. to 40° C.

The inventive method for bleaching treatment of cellulosic material may, if desired, be performed at a pH in the weakly acidic to alkaline range, in particular in the range of pH 5 to pH 12, preferably pH 8 to pH 11.

In an inventive textile washing method, preferred peroxygen concentrations (calculated as H₂O₂) in the washing solution are in the range of 0.001 g/L to 10 g/L, in particular 0.1 g/L to 1 g/L. The concentration of bleach-activating transition metal complex in the washing solution is preferably in the range of 0.1 mmol to 100 mmol/L in particular 0.5 μmol/L to 25 μmol/L.

The inventive method for bleaching treatment of cellulosic material can be implemented, for example, by adding peroxygen-containing bleaching agent, bleach-activating transition metal complex and the SPBs each separately to a treatment solution for cellulosic material, for example, a washing solution which may contain a conventional detergent. It is also possible not to use the finished bleach-activating transition metal complex but instead to use separately one or more ligands, which may form a bleach-activating transition metal complex in the process with a transition metal in situ; the transition metal may then also be added separately in the form of a salt or a non-bleach-activating complex or it may be added as a component of the process water used for the process or may be introduced into the process via the cellulosic material to be treated in the case of textiles to be cleaned, for example, as a component of the soiling to be removed. It is possible and preferable here to introduce the bleach-activating transition metal complex and the SPB simultaneously, i.e., in particular as a premix, preferably containing water and/or present in the form of an aqueous solution, or preferably in the form of an SPB containing the bleach-activating transition metal complex in colloidally bound form.

Another subject matter of the invention is the use of spherical polyelectrolyte brushes (SPB) to reduce damage to cellulosic material, for example, textiles due to the presence of bleach-activating transition metal complexes in the bleaching treatment of cellulosic material, for example, in washing textiles.

It has surprisingly been found that by using SPBs, not only is damage to cellulosic material reduced but also the bleaching performance of the system of peroxygen-containing bleaching agent and bleach-activating transition metal complex is improved. Another subject matter of the invention is therefore the use of spherical polyelectrolyte brushes (SPBs) to improve the bleaching performance of bleach-activating transition metal complex in aqueous solutions containing bleaching agent which in turn contains peroxygen.

In another preferred embodiment of the invention, an agent is used, which contains a peroxygen-containing bleaching agent, a bleach-activating transition metal complex or a ligand, which may form a bleach-activating transition metal complex with a transition metal in situ in the process, and spherical polyelectrolyte brushes (SPBs). Such a detergent which is gentle to textiles is another subject matter of the invention.

Inventive detergents, which are present in solid form or as liquids or pastes, may be used as such in machine or manual washing processes, but may also be used as detergent additives and/or as washing and/or textile pretreatment agents.

Inventive agents together with a conventional detergent are used as the detergent additive. This is appropriate in particular when the user wants to improve the bleaching performance of the usual detergent. In the wash pretreatment, the inventive agents are used to improve the removal of encrusted dirt or spots, in particular “problem spots,” such as coffee, tea, red wine, grass or fruit juice, which are difficult to remove by washing with the usual textile detergents but are accessible to oxidative attack. Another area for use of such agents is to remove local soiling from otherwise clean surfaces, making it possible to eliminate a more elaborate washing or cleaning process of the corresponding overall structure, whether a clothing item or a carpet or a furniture upholstery part. For this purpose, one may easily apply an inventive agent, optionally together with an amount of water not sufficient to completely dissolve the agent, to the textile surface and/or to the part to be cleaned, optionally also applying mechanical energy, for example, by rubbing with a cloth or a sponge, and then removing the agent and the oxidatively degraded soiling by washing out with water, for example, with the help of a moistened cloth or sponge, after a period of time to be determined by the user.

The inventive agents preferably contain 0.01 wt % to 0.5 wt %, in particular 0.02 wt % to 0.3 wt % of bleach-activating transition metal complex, which is preferably bound colloidally to the SPBs. Alternatively or optionally also additionally, the inventive agent may also contain only the SPBs plus one or more ligands capable of forming a bleach-activating transition metal complex with a transition metal in situ in the washing process. The transition metal may also be present in the detergent in the form of a salt or a non-bleach-activating complex or it may be introduced into the washing process as a component of the process water used for it or via the textile to be cleaned, for example, as a component of the soil to be removed.

The inventive detergent and cleaning agents may in principle contain all the known ingredients conventionally used in such agents, in addition to the peroxygen-containing bleaching agent, the bleach-activating transition metal complex and/or the ligand, which may form the bleach-activating transition metal complex in situ, and the SPBs. The inventive washing and cleaning agents may in particular contain builder substances, surface-active surfactants, enzymes, sequestering agents, electrolytes, pH regulators, polymers with special effects such as soil-release polymers, dye transfer inhibitors, graying inhibitors, wrinkle-reducing active ingredients and shape-retaining active ingredients and additional auxiliary substances such as optical brighteners, foam regulators, additional peroxygen activators, dyes and perfumes.

In particular organic peracids and/or peracid salts of organic acids may be considered as peroxygen compounds suitable for use in the inventive method, in the inventive use and in the inventive agents, such as phthalimidopercaproic acid, perbenzoic acid or salts of diperdodecanedioic acid, hydrogen peroxide and inorganic salts that release hydrogen peroxide under the washing conditions. These include alkali perborate, alkali percarbonate, alkali persilicate and/or alkali persulfate such as Caroat. If solid peroxygen compounds are to be used, they may be used in the form of powders or granules, which may also be coated in a manner which is known in principle. It may be expedient to add small amounts of known bleaching agent stabilizers, for example, phosphonates, borates and/or metaborates and metasilicates as well as magnesium salts such as magnesium sulfate. An inventive agent preferably contains 15 wt % to 50 wt %, in particular 18 wt % to 35 wt % peroxygen-containing bleaching agent, in particular alkali percarbonate. Alternatively or optionally additionally, hydrogen peroxide may also be produced by an enzymatic system in the inventive process, namely an oxidase in combination with its substrate, which in a preferred embodiment of the invention is a component of the inventive agent and may replace the peroxygen-containing bleaching agent partially or preferably completely in this inventive agent.

In addition to the bleach-activating transition metal complex compound, additional compounds known as bleach-activating active ingredients may, if desired, also be used in the inventive agents, in particular conventional bleach activators, i.e., compounds which yield optionally substituted perbenzoic acid and/or peroxocarboxylic acids with 1 to 10 carbon atoms, in particular 2 to 4 carbon atoms, under perhydrolysis conditions. Conventional bleach activators having O-acyl and/or N-acyl groups of the aforementioned number of carbon atoms and/or optionally substituted benzoyl groups are suitable. Polyacylated alkylenediamines, in particular tetraacetylethylenediamine (TAED), acylated glycolurils, in particular tetraacetylglycoluril (TAGU), acylated triazine derivatives, in particular 1,5-diacetyl-2,4-dioxohexahydro-1,3,5-triazine (DADHT), acylated phenylsulfonates, in particular nonanoyloxy- or isononanoyl-oxybenzenesulfonate, N-acylated caprolactam or valerolactam, in particular N-acetylcaprolactam, acylated polyvalent alcohols, in particular triacetin, ethylene glycol diacetate and 2,5-diacetoxy-2,5-dihydrofuran as well as acetylated sorbitol and mannitol and acylated sugar derivatives, in particular pentaacetyl glucose (PAG), pentaacetyl fructose, tetraacetyl xylose and octaacetyl lactose as well as acetylated, optionally N-alkylated glucamine and gluconolactone. Nitriles which form perimidic acids under perhydrolysis conditions, such as 4-morpholinecarbonitrile or ammonium group-carrying acetonitriles may also be used. However, the inventive agents are preferably free of such conventional bleach activators.

The inventive agents may contain one or more surfactants; but anionic surfactants, nonionic surfactants and mixtures thereof may be considered in particular. Suitable nonionic surfactants include in particular alkyl glycosides and ethoxylation and/or propoxylation products of alkyl glycosides or linear or branched alcohols, each with 12 to 18 carbon atoms in the alkyl part and 3 to 20, preferably 4 to 10 alkyl ether groups. In addition, corresponding ethoxylation and/or propoxylation products of N-alkylamines, vicinal diols, fatty acid esters and fatty acid amides, which correspond to the aforementioned long-chain alcohol derivatives with regard to the alkyl part, as well as alkyl phenols with 5 to 12 carbon atoms in the alkyl part may also be used.

Suitable anionic surfactants include in particular soaps and those containing sulfate or sulfonate groups, preferably with alkali ions as cations. Soaps that may be used preferably include the alkali salts of saturated or unsaturated fatty acids with 12 to 18 carbon atoms. Such fatty acids may also be used in incompletely neutralized form. Usable surfactants of the sulfate type include the salts of sulfuric acid hemiesters of fatty alcohols with 12 to 18 carbon atoms and the sulfation products of the aforementioned nonionic surfactants with a low degree of ethoxylation. Usable surfactants of the sulfonate type include linear alkylbenzene sulfonates with 9 to 14 carbon atoms in the alkyl part, alkanesulfonates with 12 to 18 carbon atoms and olefin sulfonates with 12 to 18 carbon atoms, which are formed by the reaction of corresponding monoolefins with sulfur trioxide as well as α-sulfofatty acid esters, which are formed in sulfonation of fatty acid methyl or ethyl esters.

Such surfactants are present in the inventive cleaning or detergents in amounts of preferably 5 wt % to 50 wt %, in particular 8 wt % to 30 wt %.

An inventive agent preferably contains at least one water-soluble and/or water-insoluble organic and/or inorganic builder. The water-soluble organic builder substances include polycarboxylic acids, in particular citric acid and sugar acids, monomeric and polymeric aminopolycarboxylic acids, in particular methyl glycine diacetic acid, nitrolotriacetic acid, ethylenediamine-N,N′-disuccinic acid and ethylenediamine-tetraacetic acid as well as polyaspartic acid, polyphosphonic acids in particular aminotris(methylenephosphonic acid), ethylenediaminetetrakis(methylenephosphonic acid) and 1-hydroxyethane-1,1-diphosphonic acid, polymeric hydroxyl compounds such as dextrin and polymeric (poly)carboxylic acids, in particular the polycarboxylates that are accessible by oxidation of polysaccharides and/or dextrins, polymeric acrylic acids, methacrylic acids, maleic acids and copolymers thereof, which may also contain small amounts of polymerizable substances without any carboxylic acid functionality polymerized into them. The relative molecular weight of the homopolymers of unsaturated carboxylic acids is generally between 5,000 and 200,000, while that of the copolymers is between 2,000 and 200,000, preferably from 50,000 to 120,000, each based on free acid. An especially preferred acrylic acid-maleic acid copolymer has a relative molecular weight of 50,000 to 100,000. Suitable—although less preferred—compounds of this class include copolymers of acrylic acid or methacrylic acid with vinyl ethers, such as vinyl methyl ethers, vinyl esters, ethylene, propylene and styrene, in which the amount of acid is at least 50 wt %. The water-soluble organic builder substances may also be terpolymers, which contain as monomers two unsaturated acids and/or their salts and as the third monomer vinyl alcohol and/or an esterified vinyl alcohol or a carbohydrate. The first acidic monomer and/or its salt is derived from a monoethylenically unsaturated C₃-C₈ carboxylic acid and preferably from a C₃-C₄ monocarboxylic acid, in particular (meth)acrylic acid. The second acidic monomer and/or its salt may be a derivative of a C₄-C₈ dicarboxylic acid, where maleic acid is especially preferred, and/or a derivative of an alkylsulfonic acid, which is substituted in position 2 with an alkyl or aryl radical. Such polymers usually have a relative molecular weight between 1000 and 200,000. Additional preferred copolymers include those having preferably acrolein and acrylic acid/acrylic acid salts and/or vinyl acetate as monomers. All the aforementioned acids are in general used in the form of their water-soluble salts, in particular their alkali salts.

Such organic builder substances may be present, if desired, in amounts of up to 40 wt %, in particular up to 25 wt % and preferably from 1 wt % to 8 wt %.

Water-soluble inorganic builder materials that may be considered include in particular polymeric alkali phosphates, which may be present in the form of their alkaline, neutral or acidic sodium or potassium salts. Examples include tetrasodium diphosphate, disodium dihydrogen diphosphate, pentasodium triphosphate, so-called sodium hexametaphosphate and the corresponding potassium salts and/or mixtures of sodium and potassium salts. Water-insoluble, water-dispersible inorganic builder materials used include in particular crystalline or amorphous alkali aluminosilicates in amounts of up to 50 wt %, preferably no more than 40 wt %, and in liquid agents from 1 wt % to 5 wt % in particular. Of these, the crystalline sodium aluminosilicates of detergent quality, in particular zeolite A, P and optionally X are preferred. Quantities near the aforementioned upper limit are preferably used in solid particulate agents. Suitable aluminosilicates in particular do not have any particles with a grain size of more than 30 μm and preferably consist of at least 80 wt % particles less than 10 μm in size. Their calcium binding capacity, which can be determined according to the specifications of the German Patent DE 24 12 837, is usually in the range of 100 to 200 mg CaO per gram.

Suitable substitutes and/or partial substitutes for the aforementioned aluminosilicate include crystalline alkali silicates, which may be present alone or in mixture with amorphous silicates. The alkali silicates that may be used as builders in the inventive agents preferably have a molar ratio of alkali oxide to SiO₂ of less than 0.95, in particular 1:1.1 to 1:12, and may be amorphous or crystalline. Preferred alkali silicates include sodium silicates, in particular amorphous sodium silicates with a molar ratio of Na₂O:SiO₂ of 1:2 to 1:2.8. Crystalline layered silicates of the general formula Na₂SiₓO₂ₓ₊₁≅yH₂O, where x, the so-called modulus, is a number from 1.9 to 4, and y is a number from 0 to 20, and preferred values for x are 2, 3 or 4, are preferably used as crystalline silicates, which may be present alone or in mixture with amorphous silicates. Preferred crystalline layered silicates include those in which x in the aforementioned general formula assumes the values 2 or 3. In particular both β- and δ-sodium disilicates (Na₂Si₂O₅≅yH₂O) are preferred. Practically anhydrous crystalline alkali silicates of the aforementioned general formula produced from amorphous alkali silicates, where x is a number from 1.9 to 2.1, may be used in the inventive agents. In another preferred embodiment of inventive agents, a crystalline sodium layered silicate with a modulus of 2 to 3 is used, such as that which can be produced from sand and sodium carbonate. Crystalline sodium silicates with a modulus in the range of 1.9 to 3.5 are used in another preferred embodiment of the inventive agents. In a preferred embodiment of inventive agents, a granular compound of alkali silicate and alkali carbonate, such as that available commercially under the brand name Nabion® 15, is used. If alkali aluminosilicate, in particular zeolite, is also present as an additional builder substance, then the weight ratio of aluminosilicate to silicate, each based on anhydrous active substances, is preferably 1:10 to 10:1. The weight ratio of amorphous alkali silicate to crystalline alkali silicate in agents containing both amorphous and crystalline alkali silicates is preferably 1:2 to 2:1 and in particular 1:1 to 2:1.

Builder substances are preferably present in the inventive washing or cleaning agents in amounts of up to 60 wt %, in particular from 5 wt % to 40 wt %, while the inventive disinfectants are preferably free of the builder substances, which complex only the water hardness components and preferably contain no more than 20 wt %, in particular 0.1 to 5 wt %, heavy metal complexing substances, preferably from the group comprising aminopolycarboxylic acids, aminopolyphosphonic acids and hydroxypolyphosphonic acids and their water-soluble salts and mixtures thereof.

In a preferred embodiment of the invention, an inventive agent contains a water-soluble builder block. The term “builder block” should express the fact that the agent does not contain any builder substances other than water-soluble builder substances, i.e., all the builder substances present in the agent are combined in what is characterized as a “block,” but at any rate this does not include the quantities of substances that may be present in small amounts as stabilizing additives and/or impurities in the other ingredients of the agents. The term “water soluble” should be understood to mean that the builder block dissolves without leaving a residue at the concentration which results from the use quantity of the agent containing it under the usual conditions. Preferably at least 15 wt % and up to 55 wt %, in particular 25 wt % to 50 wt % water-soluble builder block is present in the inventive agents. This is preferably composed of the components:

a) 5 wt % to 35 wt % citric acid, alkali citrate and/or alkali carbonate, which may be replaced at least proportionally by alkali bicarbonate,

b) up to 10 wt % alkali silicate with a modulus in the range of 1.8 to 2.5,

c) up to 2 wt % phosphonic acid and/or alkali phosphonate,

d) up to 50 wt % alkali phosphate and

e) up to 10 wt % polymeric polycarboxylate,

where the quantities given are also based on the total detergent and/or cleaning agent. This is also true of all the other quantity information, unless explicitly stated otherwise.

In a preferred embodiment of inventive agents, the water-soluble builder block contains at least two of the components b), c), d) and e) in amounts greater than 0 wt %.

With regard to component a), in a preferred embodiment the inventive agents contain 15 wt % to 25 wt % alkali carbonate, which may be replaced at least proportionately by alkali bicarbonate, and up to 5 wt %, in particular 0.5 wt % to 2.5 wt % citric acid and/or alkali citrate. In an alternative embodiment of the inventive agents, 5 wt % to 25 wt %, in particular 5 wt % to 15 wt % citric acid and/or alkali citrate and up to 5 wt %, in particular 1 wt % to 5 wt % alkali carbonate, which may be replaced at least proportionally by alkali bicarbonate, are present as component a). If both alkali carbonate and alkali bicarbonate are present, then component a) preferably contains alkali carbonate and alkali bicarbonate in a weight ratio of 10:1 to 1:1.

With regard to component b), in a preferred embodiment of the inventive agents, 1 wt % to 5 wt % alkali silicate with a modulus in the range of 1.8 to 2.5 may be present.

With regard to component c), in a preferred embodiment of the inventive agents, 0.05 wt % to 1 wt % phosphonic acids and/or alkali phosphonate are present. Of the phosphonic acids, optionally substituted alkyl and aryl phosphonic acids such as phenyl phosphonic acid, for example, are understood; these may also contain multiple phosphonic acid groupings (so-called polyphosphonic acids). They are preferably selected from the hydroxy- and/or aminoalkylphosphonic acids and/or their alkali salts, for example, dimethylaminomethane diphosphonic acid, 3-aminopropane-1-hydroxy-1,1-diphosphonic acid, 1-amino-1-phenylmethanediphosphonic acid, 1-hydroxyethane-1,1-diphosphonic acid (HEDP), amino-tris(methylenephosphonic acid), and acylated derivatives of phosphorous acid, which may also be used in any mixtures.

With regard to component d), in a preferred embodiment of the inventive agents, 15 wt % to 35 wt % alkali phosphate, in particular trisodium polyphosphate, is present. Alkali phosphate is the umbrella term for the alkali metal salts (in particular sodium and potassium salts) of the various phosphoric acids, and a distinction can be made between metaphosphoric acids (HPO₃)ₙ and orthophosphoric acid H₃PO₄ in addition to higher molecular representatives. Phosphates combine several advantages: they act as alkali carriers, prevent lime deposits on machine parts and/or lime encrustations in fabrics and also contribute toward the cleaning performance. Sodium dihydrogen phosphate NaH₂PO₄ exists as a dihydrate (density 1.91 gcm⁻³, melting point 60° C.) and as a monohydrate (density 2.04 gcm⁻³). Both salts are white powders, which are very highly soluble in water, lose their water of crystallization on heating and are converted into the weakly acidic diphosphate (disodium hydrogen diphosphate Na₂H₂P₂O₇) at 200° C., and into sodium trimetaphosphate (Na₃P₃O₉) and Madrell's salt at a higher temperature. NaH₂PO₄ gives an acidic reaction and is formed when phosphoric acid is adjusted to a pH of 4.5 with sodium hydroxide solution and the slurry is sprayed. KH₂PO₄, potassium dihydrogen phosphate (primary or monobasic potassium phosphate, potassium biphosphate KDP), is a white salt with a density of 2.33 gcm⁻³, has a melting point of 253° C. (decomposes, forming (KPO₃)ₓ, potassium polyphosphate, and is readily soluble in water. Disodium hydrogen phosphate (secondary sodium phosphate) Na₂HPO₄ is a colorless, crystalline, highly water-soluble salt. It exists in an anhydrous form and in forms with 2 mol water (density 2.066 gcm³, water loss at 95° C.), 7 mol water (density 1.68 gcm⁻³, melting point 48° C. with the loss of 5H₂O) and 12 mol water (density 1.52 gcm⁻³, melting point 35° C. with a loss of 5H₂O), becoming anhydrous at 100° C. and, with further heating, developing into the diphosphate, Na₄P₂O₇. Disodium hydrogen phosphate is synthesized by neutralizing phosphoric acid with sodium carbonate solution using phenolphthalein as an indicator. K₂HPO₄ or dipotassium hydrogen phosphate (secondary or dibasic potassium phosphate) is an amorphous white salt, which is readily soluble in water. Trisodium phosphate, tertiary sodium phosphate, Na₃PO₄, forms colorless crystals, which, as the dodecahydrate, have a density of 1.62 gcm³ and a melting point of 73-76° C. (decomp), as the decahydrate (corresponding to 19-20% P₂O₅) have a melting point of 100° C. and in anhydrous form (corresponding to 39-40% P₂O₅) have a density of 2.536 gcm⁻³. Trisodium phosphate is readily soluble in water, giving an alkaline reaction, and is synthesized by evaporating a solution of exactly 1 mol disodium phosphate and 1 mol NaOH. Tripotassium phosphate (tertiary or tribasic potassium phosphate), K₃PO₄, is a white deliquescing granular powder which has a density of 2.5 gcm⁻³, a melting point of 1340° C., is readily soluble in water and gives an alkaline reaction. It is formed on heating Thomas slag with coal and potassium sulfate, for example. Despite the higher price, the more readily soluble and therefore highly effective potassium phosphates are often preferred in the cleaning agent industry in comparison with the corresponding sodium compounds. Tetrasodium diphosphate (sodium pyrophosphate), Na₄P₂O₇, exists in an anhydrous form (density 2.534 gcm⁻³, melting point 988° C., also reported as 880° C.) and as a decahydrate (density 1.815-1.836 gcm⁻³, melting point 94° C. with loss of water). With these substances there are colorless crystals, which are soluble in water with an alkaline reaction. Na₄P₂O₇ is formed on heating disodium phosphate to >200° C. or by reacting phosphoric acid with sodium carbonate in a stoichiometric ratio and dehydrating the solution by spraying. The decahydrate forms complexes with heavy metal salts and substances that cause water hardness and thereby reduces the hardness of the water. Potassium diphosphate (potassium pyrophosphate), K₄P₂O₇, exists in the trihydrate form, which is a colorless hygroscopic powder with a density of 2.33 gcm⁻³; it is soluble in water in which a 1% solution at 25° C. has a pH of 10.4. Higher molecular sodium and potassium phosphates are formed by condensation of NaH₂PO₄ and/or KH₂PO₄, in which cyclic representatives, the sodium and/or potassium metaphosphates and chain-type compounds, the sodium and/or potassium polyphosphates, can be differentiated. A variety of terms are customarily used for the latter, in particular: fused phosphate or calcined phosphate, Graham's salt, Kurrol's salt and Madrell's salt. All higher sodium and potassium phosphates are referred to jointly as condensed phosphates. The industrially important pentasodium triphosphate, Na₅P₃O₁₀ (sodium tripolyphosphate), is a white, water-soluble, non-hygroscopic salt of the general formula NaO—[P(O)(ONa)—O]ₙ—Na, where n=3, which is anhydrous or crystallizes with 6H₂O. Approx. 17 g of the anhydrous salt will dissolve in 100 g water at room temperature, approx. 20 g will dissolve at 60° C., and approx. 32 g will dissolve at 100° C. After heating the solution for 2 hours at 100° C., approx. 8% orthophosphate and 15% diphosphate are formed by hydrolysis. In the synthesis of pentasodium triphosphate, phosphoric acid is reacted with sodium carbonate solution or sodium hydroxide solution in a stoichiometric ratio, and the solution is dehydrated by spraying. Like Graham's salt and sodium diphosphate, pentasodium triphosphate will dissolve many insoluble metal compounds (including lime soaps, etc.). Pentapotassium triphosphate K₅P₃O₁₀ (potassium tripolyphosphate) is marketed in the form of a 50 wt % solution (>23% P₂O₅, 25% K₂O), for example. Potassium polyphosphates are widely used in the washing and cleaning agent industry. In addition, there are sodium potassium tripolyphosphates, which can also be used within the scope of the present invention. These are formed when sodium trimetaphosphate is hydrolyzed with KOH, for example:

(NaPO₃)₃+2KOH→Na₃K₂P₃O₁₀+H₂O

These can be used exactly the same according to the invention as sodium tripolyphosphate, potassium tripolyphosphate or mixtures of these two; mixtures of sodium tripolyphosphate and sodium potassium tripolyphosphate or mixtures of potassium tripolyphosphate and sodium potassium tripolyphosphate or mixtures of sodium tripolyphosphate and potassium tripolyphosphate and sodium potassium tripolyphosphate can also be used according to the invention.

With regard to component e), in a preferred embodiment of the inventive agents, 1.5 wt % to 5 wt % polymeric polycarboxylate, selected in particular from the polymerization products and/or copolymerization products of acrylic acid, methacrylic acid and/or maleic acid is present. Of these, the homopolymers of acrylic acid are preferred, and of these in turn those having an average molecular weight in the range of 5000 D to 15,000 D (PA standard) are particularly preferred.

In addition to the above mentioned oxidase, enzymes that may be used in these agents also include those from the class of proteases, lipases, cutinases, amylases, pullulanases, mannanases, cellulases, hemicellulases, xylanases and peroxidases as well as mixtures thereof, for example, proteases such as BLAP®, Optimase®, Opticlean®, Maxacal®, Maxapem®, Alcalase®, Esperase®, Savinase®, Durazym® and/or Purafect® OxP, amylases such as Termamyl®, Amylase-LT®, Maxamyl®, Duramyl® and/or Purafect® OxAm, lipases such as Lipolase®, Lipomax®, Lumafast® and/or Lipozym®, cellulases such as Celluzyme® and/or Carezyme®. Enzymatic active ingredients obtained from fungi or bacteria are especially suitable such as Bacillus subtilis, Bacillus licheniformis, Streptomyces griseus, Humicola lanuginosa, Humicola insolens, Pseudomonas pseudoalcaligenes or Pseudomonas cepacia. The enzymes that are optionally used may be adsorbed onto carrier substances and/or embedded into coating substances to protect them from premature inactivation. They are present in the inventive detergents, cleaning agents and disinfectants, preferably in amounts up to 10 wt %, in particular from 0.2 wt % to 2 wt %, whereby enzymes stabilized against oxidative degradation are especially preferred for use here.

In a preferred embodiment of the invention, the agent contains 5 wt % to 50 wt %, in particular 8-30 wt % anionic and/or nonionic surfactant, up to 60 wt %, in particular 5-40 wt % builder substance and 0.2 wt % to 2 wt % enzymes selected from the proteases, lipases, cutinases, amylases, pullulanases, mannanases, cellulases, oxidases and peroxidases as well as mixtures thereof.

To adjust a desired pH, which does not result automatically from mixing the other components when adding water, the inventive agents may also contain acids, which are compatible with the system and are environmentally friendly, in particular citric acid, acetic acid, tartaric acid, malic acid, lactic acid, glycolic acid, succinic acid, glutaric acid and/or adipic acid, but also mineral acids, in particular sulfuric acid, or bases, in particular ammonium or alkali hydroxides. Such pH regulators are preferably present in the inventive agents in amounts of no more than 20 wt %, in particular 1.2 wt % to 17 wt %.

Soil release-enabling polymers, often referred to as “soil release” active ingredients or as “soil repellents” because of their ability to impart a soil-repellent finish to the treated surface, for example, the fiber, include nonionic or cationic cellulose derivatives, for example. The polyester-active soil-release polymers in particular include copolyesters of dicarboxylic acids, for example, adipic acid, phthalic acid or terephthalic acid, diols, for example, ethylene glycol or propylene glycol, and polydiols, for example, polyethylene glycol or polypropylene glycol. The preferred soil release-enabling polyesters for use here include those compounds which are accessible formally by esterification of two monomer parts, where the first monomer is a dicarboxylic acid, HOOC-Ph-COOH, and the second monomer is a diol, HO—(CHR²¹)ₐOH, which may also be present as a polymeric diol, H—(O—(CHR²¹)ₐ)_{b}OH, where Ph denotes an o-, m- or p-phenylene radical, which may have 1 to 4 substituents, selected from alkyl radicals with 1 to 22 carbon atoms, sulfonic acid groups, carboxyl groups and mixtures thereof, R²¹ is hydrogen, an alkyl radical with 1 to 22 carbon atoms and mixtures thereof, a is a number from 2 to 6, and b is a number from 1 to 300. The polyesters obtainable from these contain both monomer diol units O—(CHR²¹)ₐO and polymer diol units (O—(CHR²¹)ₐ)_{b}O. The molar ratio of monomer diol units to polymer diol units is preferably 100:1 to 1:100, in particular 10:1 to 1:10. The degree of polymerization b in the polymer diol units is preferably in the range of 4 to 200, in particular 12 to 140. The molecular weight and/or the average molecular weight or the maximum of the molecular weight distribution of preferred soil release polyesters is in the range of 250 to 100,000, in particular from 500 to 50,000. The acid on which the Ph radical is based is preferably selected from terephthalic acid, isophthalic acid, phthalic acid, trimellitic acid, mellitic acid, the isomers of sulfophthalic acid, sulfoisophthalic acid and sulfoterephthalic acid as well as mixtures thereof. If their acid groups are not part of the ester bonds in the polymer, they are preferably in salt form, in particular as the alkali or ammonium salt. Of these, the sodium and potassium salts are especially preferred. If desired, instead of the monomer HOOC—Ph-COOH, small amounts, in particular no more than 10 mol %, based on the amount of Ph with the meaning given above, other acids having at least two carboxyl groups may also be present in the soil release polyester. These include, for example, alkylene and alkenylene dicarboxylic acids such as malonic acid, succinic acid, fumaric acid, maleic acid, glutaric acid, adipic acid, pimelic acid, suberic acid, azelaic acid and sebacic acid. The preferred diols HO—(CHR²¹)ₐOH include those in which R²¹ is hydrogen, and a is a number from 2 to 6, and those in which a has the value 2 and R¹¹ is selected from hydrogen and alkyl radicals with 1 to 10 carbon atoms, in particular 1 to 3 carbon atoms. Of the diols mentioned last, those of the formula HO—CH₂—CHR¹¹—OH, in which R¹¹ has the meanings given above, are especially preferred. Examples of diol components include ethylene glycol, 1,2-propylene glycol, 1,3-propylene glycol, 1,4-butanediol, 1,5-pentanediol, 1,6-hexanediol, 1,8-octanediol, 1,2-decanediol, 1,2-dodecanediol and neopentyl glycol. Of the polymeric diols, polyethylene glycol with an average molecular weight in the range of 1000 to 6000 is especially preferred. If desired, these polyesters may also be end-group-capped, where alkyl groups with 1 to 22 carbon atoms and esters of monocarboxylic acids may be considered as end groups. The end groups bound by ester bonds may be based on alkyl, alkenyl and aryl monocarboxylic acids with 5 to 32 carbon atoms, in particular 5 to 18 carbon atoms. These include valeric acid, caproic acid, enanthic acid, caprylic acid, pelargonic acid, capric acid, undecanoic acid, undecenoic acid, lauric acid, lauroleic acid, tridecanoic acid, myristic acid, myristoleic acid, pentadecanoic acid, palmitic acid, stearic acid, petroselinic acid, petroselaidic acid, oleic acid, linoleic acid, linolaideic acid, linolenic acid, elaostearic acid, arachic acid, gadoleic acid, arachidonic acid, behenic acid, erucaic acid, brassidic acid, clupanodonic acid, lignoceric acid, cerotinic acid, melissic acid, benzoic acid, which may have 1 to 5 substituents with a total of up to 25 carbon atoms, in particular 1 to 12 carbon atoms, for example, tert-butyl benzoic acid. The end groups may also be based on hydroxymonocarboxylic acids with 5 to 22 carbon atoms, including, for example, hydroxyvaleric acid, hydroxycaproic acid, ricinoleic acid, their hydrogenation product, hydroxystearic acid, as well as o-, m- and p-hydroxybenzoic acid. The hydroxymonocarboxylic acids may in turn be linked together by their hydroxyl group and their carboxyl group and may thus be present several times in one end group. The number of hydroxymonocarboxylic acid units per end group, i.e., their degree of oligomerization is preferably in the range of 1 to 50 in particular 1 to 10. In a preferred embodiment of the invention, polymers of ethylene terephthalate and polyethylene oxide terephthalate, in which the polyethylene glycol units have molecular weights of 750 to 5000 and the molar ratio of ethylene terephthalate to polyethylene oxide terephthalate is 50:50 to 90:10, may be used alone or in combination with cellulose derivatives.

The dye transfer inhibitors which may be considered for use in the inventive agents for washing textiles include in particular polyvinylpyrrolidones, polyvinylimidazoles, polymeric N-oxides such as poly(vinylpyridine N-oxide) and copolymers of vinylpyrrolidone with vinylimidazole and optionally other monomers.

The inventive agents for use in washing textiles may contain antiwrinkle agents because textile sheeting made of rayon, wool, cotton and blends thereof in particular may tend to wrinkle because the individual fibers are sensitive to bending, folding, pressing and squeezing across the direction of the fiber. These include, for example, synthetic products based on fatty acids, fatty acid esters, fatty acid amides, alkylol esters, alkylol amides or fatty alcohols, most of which are reacted with ethylene oxide, or products based on lecithin or modified phosphoric acid esters.

Graying inhibitors have the function of keeping the soil released from the hard surface and in particular from the textile fiber suspended in the solution. Water-soluble colloids, usually of an organic nature, are suitable for this purpose, for example, starch, glue, gelatin, salts of ether carboxylic acids or ether sulfonic acids of starch or cellulose or salts of acidic sulfate esters of cellulose or of starch. Water-soluble polyamides containing acidic groups are also suitable for this purpose. In addition, starch derivatives other than those mentioned above may also be used, for example, aldehyde starches. Cellulose ethers such as carboxymethyl cellulose (Na salt), methyl cellulose, hydroxyalkyl cellulose and mixed ethers such as methylhydroxyethyl cellulose, methyl-hydroxypropyl cellulose, methylcarboxymethyl cellulose and mixtures thereof, for example, in amounts of 0.1 to 5 wt %, based on the agent, are preferred.

The detergents may contain optical brighteners, in particular derivatives of diaminostilbene disulfonic acid and/or their alkali metal salts. For example, salts of 4,4′-bis(2-anilino-4-morpholino-1,3,5-triazinyl-6-amino)stilbene-2,2′-disulfonic acid or compounds of a similar structure containing, instead of the morpholino group, a diethanolamine group, a methylamino group, an anilino group or a 2-methoxyethylamino group, are also suitable. In addition, brighteners of the substituted diphenylstyryl type may also be present, for example, the alkali salts of 4,4′-bis(2-sulfostyryl)diphenyls, 4,4′-bis(4-chloro-3-sulfostyryl)diphenyls or 4-(4-chlorostyryl)-4′-(2-sulfostyryl)diphenyls. Mixtures of the aforementioned optical brighteners may also be used.

For use in machine washing and cleaning processes in particular, it may be advantageous to add the usual foam inhibitors to these agents. Suitable foam inhibitors include, for example, soaps of natural or synthetic origin containing a large amount of C₁₈-C₂₄ fatty acids. Suitable non-surfactant foam inhibitors include, for example, organopolysiloxanes and mixtures thereof with microfine optionally silanized silicic acid as well as paraffins, waxes, microcrystalline waxes and mixtures thereof with silanized silicic acid or bis-fatty acid alkylenediamides. Mixtures of various foam inhibitors may also be used to advantage, for example, those of silicones, paraffins or waxes. The foam inhibitors, in particular foam inhibitors containing silicone and/or paraffin, are preferably ground to a granular carrier substance which is water-soluble and/or water-dispersible. Mixtures of paraffins and bistearylethylenediamide are preferred in particular.

Active ingredients to prevent tarnishing of objects made of silver, so-called silver corrosion inhibitors, may also be used in the inventive agents. Preferred silver corrosion inhibitors include organic disulfides, divalent phenols, trivalent phenols, optionally alkyl- or aminoalkyl-substituted triazoles such as benzotriazole as well as cobalt, manganese, titanium, zirconium, hafnium, vanadium or cerium salts and/or complexes in which the aforementioned metals are present in one of the oxidation stages II, III, IV, V or VI.

An inventive agent may also contain the usual antimicrobial active ingredients to potentiate the disinfectant effect with respect to special microbes, in addition to containing the aforementioned ingredients. Such antimicrobial additives are preferably contained in the inventive agents in amounts of no more than 10 wt %, in particular from 0.1 wt % to 5 wt %.

An inventive cleaning agent for hard surfaces may also contain abrasive active ingredients, in particular from the group comprising powdered quartz, wood dust, plastic powder, chalk and microglass beads as well as mixtures thereof. Abrasive substances are preferably present in the inventive cleaning agents in amounts of no more 20 wt %, in particular 5 wt % to 15 wt %.

### EXAMPLES

Spherical polyelectrolyte brushes (SPBs) with a polystyrene core and acrylic acid grafted onto them were produced by the method described by X. Guo, A Weiss and M. Ballauff in Macromolecules, 1999, pages 6043-6046. An aqueous dispersion of an SPB produced in this way was diluted with water to a solids content of 1 wt %; 25 mol %, based on the molar functional group content in the polyelectrolyte shell, of 1,4,7-trimethyl-1,4,7-triazacyclononane-manganese complex, Mn-Me₃TACN, was added at room temperature and pH 5 while stirring, whereupon the Mn-Me₃TACN was added by controlled ion exchange via ultrafiltration or simply as a solid powder. The mixture was stirred for 24 hours. Next the SPBs loaded with the catalyst were isolated by centrifugation.

Primary detergency and loss of wet tensile strength were tested in a miniaturized washing test. The test was conducted using a simplified washing solution V1 consisting of aqueous H₂O₂ and SPB-Mn-Me₃TACN composite particles. A mixture of 0.35 g/L H₂O₂ and SPB-MN-Me₃TACN composite particles was used in an amount corresponding to 5 mg/L Mn, in water of the hardness 16° dH [German degrees of water hardness] whose pH had been adjusted to pH 10.5 by means of NaOH. For comparison, a solution M1 which did not contain the SPB-MnO2 composite particles, and another solution M2, which contained the free Mn-Me3TACN complex in an amount corresponding to 5 mg/L Mn instead of the SPB-Mn-Me3TACN composite particle, were also tested.

For measurement of the primary detergency, cotton substrates, which had been provided with a standardized tea soiling, were treated for 30 minutes at 30° C. in the respective solutions. The treated fabric substrate was washed out under running water and then dried and a color measurement was performed. The following table shows the brightness value of the cotton test pieces.

For measuring the loss of wet tensile strength, cotton strips of a defined width (number of threads) were treated 20 times over 45 minutes each at 60° C. in the respective solutions. The strips were dried and immersed in a wetting solution before being torn by a tensile testing machine at a constant tensile test speed. The tear strength of the treated cotton was compared with the tear strength of the untreated cotton, and the results were calculated in loss of wet tensile strength in percentage.

Five determinations each were performed for the primary detergency and the loss of wet tensile strength. The averages are given in the following table.

| | Bleaching performance | Loss of wet tensile |
|---|---|---|
| | (Y value) | strength (%) |
| V1 | 54.3 | 7 |
| M1 | 59.9 | 77 |
| M2 | 59.9 | 49 |

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A bleaching agent comprising spherical polyelectrolyte brushes that contain bleach-potentiating transition metal complex compound in colloidally bound form.

2. A bleaching agent according to claim 1, wherein the bleach-potentiating transition metal complex compound is a metal complex of formula (I)
[LₙMₘXₚ]^{z}Y_{q} (I)
wherein M denotes manganese or iron or mixtures of these metals, which may be present in oxidation states II, III, IV or V or in mixtures of same, n and m, independently of one another, denote integers with a value from 1 to 4, X is a coordinating or bridging species, p is an integer with a value of 0 to 12, Y is a counterion, the type of which depends on the charge z of the complex, which may be positive, zero or negative, q=z/[charge Y] and L is a ligand, which is a macrocyclic organic molecule of the general formula 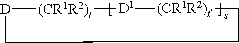
wherein each of the radicals R¹ and R² is zero, H, alkyl or aryl, optionally substituted; t and t′, independently of one another, are 2 or 3; D and D¹, independently of one another, are N, NR, PR, O or S, wherein R is H, alkyl or aryl optionally substituted; and s is an integer with a value of 2 to 5, wherein if D=N, one of the heterocarbon bonds bonded to it is unsaturated, which leads to creation of an N═CR¹ fragment.

3. The bleaching agent according to claim 2, wherein the complex corresponds to the formula (I), where M=manganese and L=1,4,7-triazacyclononane, 1,4,7-trimethyl-1,4,7-triazacyclononane, 1,5,9-trimethyl-1,5,9-triazacyclododecane or 1,2,4,7-tetramethyl-1,4,7-triazacyclononane.

4. The bleaching agent according to claim 1, wherein the bleach-potentiating transition metal complex compound is a manganese complex of formula (II) 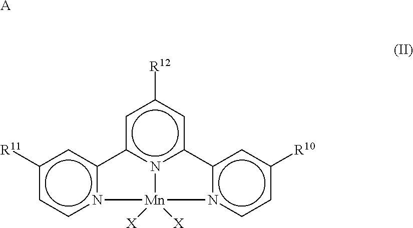
wherein R¹⁰ and R¹¹, independently of one another, stand for hydrogen, a C₁₋₁₈ alkyl group, an NR¹³R¹⁴ group, an N⁺R¹³R¹⁴R¹⁵ group or a 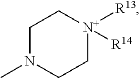
group, wherein R¹² stands for hydrogen, OH or a C₁₋₁₈ alkyl group, R¹³, R¹⁴ and R¹⁵ independently of one another stand for hydrogen, a C₁₋₄ alkyl or hydroxyalkyl group and X stands for halogen and A stands for a charge-equalizing anion, which may also be omitted or may be present multiple times, depending on its charge and the type and number of other charges, in particular the charge of the manganese central atom.

5. A method for producing spherical polyelectrolyte brushes that contain a bleach-activating transition metal complex compound in colloidally bound form, wherein a spherical polyelectrolyte brush comprising a polyelectrolyte shell having functional groups is brought in contact with the bleach-activating transition metal complex compound in the presence of water.

6. The method according to claim 5, wherein the molar ratio between the molar number of functional groups in the polyelectrolyte shell to the added transition metal complex compound is in the range of 100:1 to 2:1.

7. A method for producing spherical polyelectrolyte brushes (SPBs) that contain a bleach-activating transition metal complex compound in colloidally bound form, wherein one or more ligands capable of forming a bleach-potentiating transition metal complex in situ with a transition metal and the corresponding transition metal in salt form or in the form of a non-bleach-active complex are brought in contact with a spherical polyelectrolyte brush (SPB) in the presence of water.

8. A method for bleaching treatment of cellulosic material in the presence of a bleaching agent which contains peroxygen and of a bleach-potentiating transition metal complex, wherein it is performed in the presence of spherical polyelectrolyte brushes (SPBs) in a wash liquor.

9. The method according to claim 8, wherein it is performed at temperatures in the range of 10° C. to 95° C.

10. The method according to claim 9, wherein it is performed at a pH in the range of pH 5 to pH 12.

11. The method according to claim 10, wherein the peroxygen concentration (calculated as H₂O₂) in the wash liquor is in the range of 0.001 g/L to 10 g/L.

12. The method according to claim 8, wherein the bleach-potentiating transition metal complex is formed in-situ using separately one or more ligands, that are capable of forming a bleach-potentiating transition metal complex with a transition metal in the process, and wherein the transition metal is also added separately in the form of a salt or a non-bleach-potentiating complex or it is introduced as a component of the wash liquor or is introduced via the cellulosic material to be treated.

13. A detergent comprising a bleaching agent, which in turn comprises peroxygen, and spherical polyelectrolyte brushes containing a bleach-potentiating transition metal complex in colloidally bound form.
